(19) United States
(12) Patent Application Publication
(10) Pub. No.: US 2011/0158358 A1
(43) Pub. Date: Jun. 30, 2011

(54) System for selecting a sample phase based on channel capacity

(75) Inventors: Chun-Chieh TSENG, Guishan Township (TW); Guo-Li LAI, Taichung City (TW); Liang-Ying CHEN, Tanzi Township (TW)

(73) Assignee: Sunplus Technology Co., Ltd., Hsinchu (TW)

(21) Appl. No.: 12/926,016

(22) Filed: Oct. 21, 2010

(30) Foreign Application Priority Data
Dec. 24, 2009 (TW) 098144698

(51) Int. Cl. H04L 27/06

(52) U.S. Cl. 375/344

(57) ABSTRACT

The present invention provides a system for selecting a sample phase based on channel capacity. A synchronizer calculates a carrier frequency offset, a sample timing offset, a sampling conversion rate and a frame timing, and counts the candidate sample phases. A digital mixer conducts frequency offset compensation to produce a frequency compensated baseband signal. An interpolator conducts interpolation to compensate and produce an interpolated baseband signal. A digital matched filter performs filtering to produce an over-sampled and filtered baseband signal. A buffer stores the over-sampled and filtered baseband signal. A channel estimator estimates and produces channel frequency responses. A sample phase selector calculates channel capacity corresponding to each candidate sample phase, and selects the one with maximum channel capacity. A down-sampler conducts down-sampling operation to produce the final symbol rate based baseband signal. As such, symbol synchronization can be achieved with enhanced performance.

### BACKGROUND OF THE INVENTION

1. Field of the Invention

The present invention relates to the technical field of signal transmission and, more particularly, to a system used for selecting a sample phase based on channel capacity.

2. Description of Related Art

In the conventional digital communication, an analog-to-digital converter (ADC) is used to perform over-sampling on the received signal. According to sampling theorem, the employed sampling rate must be no less than twice the system bandwidth. Typically, system bandwidth is the symbol rate of the transmitted signal. The term of over-sampling factor, denoted by κ, is often used to define the ratio of sampling rate to the system bandwidth. Typical value of κ is set as 2 or 4, up to tradeoff between easy adjacent interference suppressing by low order filter design and marginal increase of implementation complexity. In practical situation, however, sampling rate is always inaccurate due to imperfect properties of crystal oscillator and frequency synthesizer. As a result, the actual κ value is slightly different from the ideal integer.

In the prior art, a symbol timing synchronization process is employed to estimate the symbol rate and correct possible sample timing offset to further indirectly obtain the ideal κ value so as to achieve sampling timing synchronization. In general, symbol timing synchronization is achieved by employing an interpolator to perform interpolation or extrapolation operation based on the symbol rate and sample timing offset predicted by a synchronizer. Consequently, the output of interpolator works at expected sampling rate to restore the accurate symbol rate and sampling at correct timing.

FIG. 1 is a block diagram of a synchronization mechanism of a typical digital receiver. As shown in FIG. 1, the ADC 310 converts an analog baseband signal into a digital baseband signal based on an over-sampling factor κ. Without loss of generality, only the scenario corresponding to zero-IF tuner is described here. The digital mixer 320 performs a frequency shifting on the digital baseband signal based on a carrier frequency offset. The interpolator 230 performs an interpolation operation on the offset baseband signal based on a sample timing offset and sampling conversion rate, wherein, the sampling conversion rate is defined as a ratio of sampling rates of input and output signals of the interpolator 230. In this case, the sampling rate of the output signal of the interpolator 230 is regulated to the symbol rate, and the original sampling rate is used to be the data inputted to the interpolator 230. The output signal of the interpolator 230 is filtered by the digital matched filter (DMF) 340. Next, the channel equalizer 370 is based on the synchronous message provided by the synchronizer 360 to pre-store a part of the signal in a buffer 350.

Up to properties of a system under consideration, the design philosophy for synchronization might be different. Usually, synchronization and compensation of a carrier frequency is conducted first, and then the symbol synchronization and frame synchronization are performed at time domain. The resulted phase error due to residual frequency offset, residual timing offset and phase noise are then tracked by a timing recovery loop (not shown) and a phase tracking loop (not shown).

In general, synchronization and tracking algorithms can be classified as data aided, non-data aided, decision-directed, and the like. For systems without frame header or preamble that transmits continuously at time domain, data aided or the decision-directed synchronization is hard to be achieved especially under multi-path channel. In this scenario, Gardner provides a timing-error detector, known as being the most commonly used non-data aided symbol timing synchronization algorithm generally suitable for all QAM modulations. It predicts symbol timing by tracking symmetry of signal peaks at time domain. (see Floyd M. Gardner, ‘A BPSK/QPSK Timing-Error Detector for Sampled Receiver,’ IEEE Trans. Commun., vol. COM-34., No. 5, May 1986). On the other hand, frame-based communication system typically equipped with a correlator to perform correlation between incoming signal and local duplicate of a known transmitted signal such as frame header or preamble, and further conduct peak detection on the corresponding correlator output to thereby achieve symbol and frame synchronization. As cited, the peak period of signal at time domain is detected to thereby estimate the symbol rate, and the symmetry of peak positions is continuously tracked to thereby decide the sample timing offset, which finally passes through the interpolator to accordingly operate and achieve expected symbol synchronization.

However, transmission property under frequency selective channel is sensitive to sample timing offset. Sampling a signal at symbol rate but with different sample timing offsets leads to different best achievable performance bounded by channel capacity of the different underlying channel. Hence, sample timing offset estimation obtained simply by tracking and estimating the abovementioned peak symmetry is not sufficient and reliable under generic transmission conditions.

Therefore, it is desirable to provide an improved system for selecting a sample phase based on channel capacity to mitigate and/or obviate the aforementioned problems.

### SUMMARY OF THE INVENTION

The object of the present invention is to provide a system for selecting a sample phase, which can provide a message of selecting the sample phase to thereby achieve symbol timing synchronization and thereby enhance the whole system performance. In addition, the sample phase is selected based on evaluation and selection among channel capacities associated with all possible sample phases. This point is unique to the prior art.

According to a feature of the invention, a system for selecting a sample phase based on channel capacity is provided. The system includes a synchronizer, a digital mixer, an interpolator, a digital matched filter, a buffer, a down-sampler and a sample phase selector. The synchronizer is employed to provide the estimation of carrier frequency offset (CFO), sample timing offset, sampling conversion rate and frame timing. It also counts candidate sample phases to be selected. The digital mixer receives a digital baseband signal and performs a frequency compensation on the digital baseband signal based on the estimated carrier frequency offset to thereby generate an offset baseband signal. The interpolator is connected to the digital mixer in order to perform an interpolation operation on the offset baseband signal according to the estimated sample timing offset and the sampling conversion rate, to thereby compensate and generate an interpolated offset baseband signal. The digital matched filter is connected to the interpolator in order to perform a filtering on the interpolated offset baseband signal to thereby generate an over-sampled filter baseband signal. The buffer is connected to the digital matched filter in order to temporarily store the over-sampled filter baseband signal according to the estimated frame timing. The down-sampler is connected to the buffer in order to perform a down-sampling operation on the over-sampled filter baseband signal according to a phase selection index, to thereby generate a down-sampled filter baseband signal. The sample phase selector is connected to the down-sampler in order to calculate a channel capacity corresponding to the candidate sample phase index based on a channel frequency response and the abovementioned candidate sample phase index, to thereby select a candidate sample phase with the maximum capacity as the phase selection index. The over-sampled filter baseband signal has multiple baseband signals. The phase selection index is based on one of the baseband signals to thereby generate the down-sampled filter baseband signal.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a synchronization mechanism of a typical digital receiver;

FIG. 2 is a block diagram of a system for selecting a sample phase based on channel capacity according to the invention; and

FIGS. 3 to 6 are schematic diagrams of simulations according to the invention.

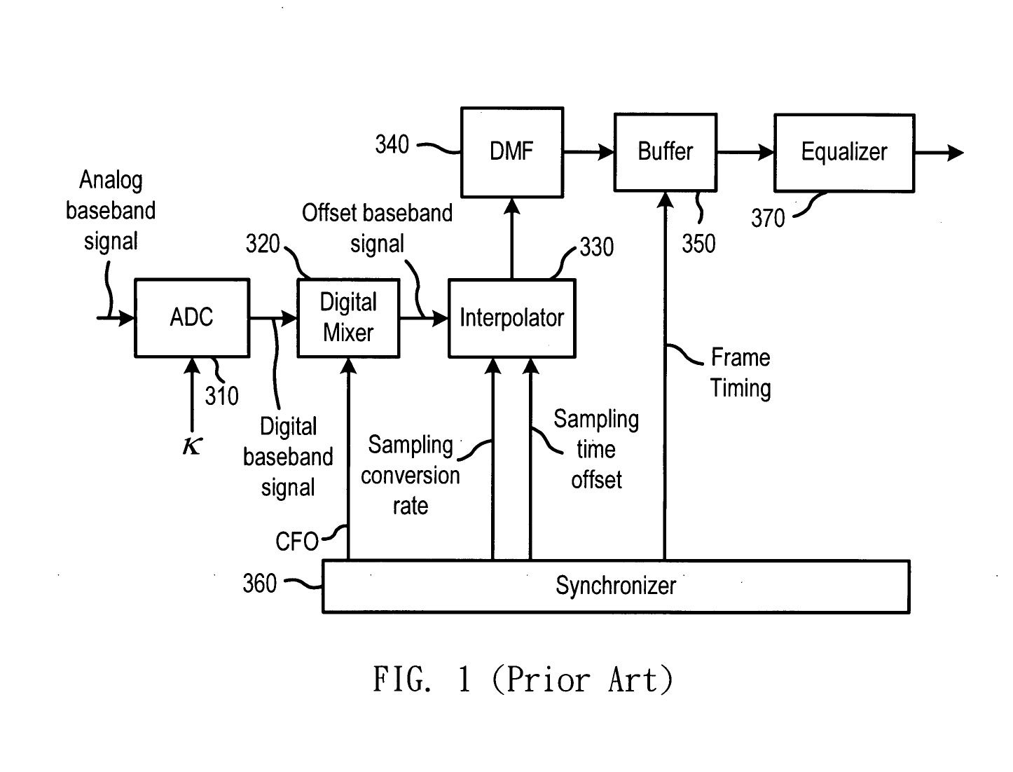

### DETAILED DESCRIPTION OF THE PREFERRED EMBODIMENT

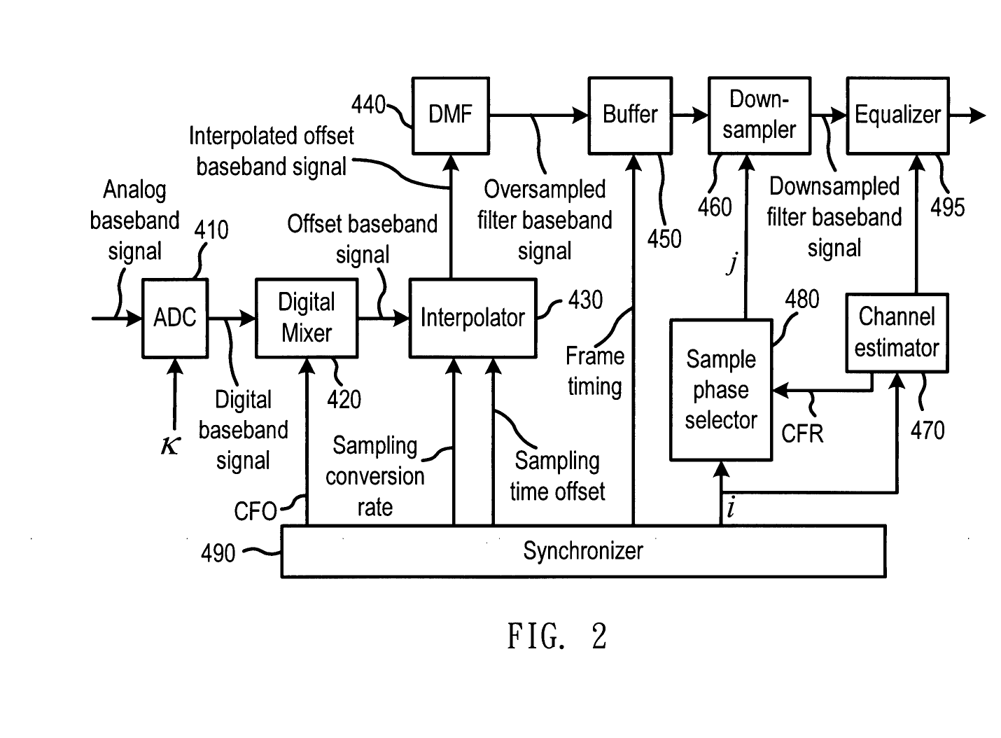

FIG. 2 is a block diagram of a system for selecting a sample phase based on channel capacity according to the invention. The system is applied to a receiver of a wireless communication system using a carrier to transmit signals. The system includes an analog to digital converter (ADC) 410, a digital mixer 420, an interpolator 430, a digital matched filter 440, a buffer 450, a down-sampler 460, a channel estimator 470, a sample phase selector 480, a synchronizer 490, and an equalizer 495.

The ADC 410 is connected to the digital mixer 420 in order to convert an analog baseband signal into a digital baseband signal based on an over-sampling factor κ, which is in general an integer 2 or 4.

The synchronizer 490 estimates a carrier frequency offset (CFO), a sample timing offset, a sampling conversion rate and a frame timing in the communication system, and counts candidate sample phases to be selected. In practice, the input signal required for the synchronizer 490 is up to the algorithm employed in the system under consideration.

The digital mixer 420 receives the digital baseband signal and performs a frequency compensation on the digital baseband signal based on the carrier frequency offset to thereby generate an offset baseband signal.

The interpolator 430 is connected to the digital mixer 420 in order to perform an interpolation operation on the offset baseband signal based on the sample timing offset and the sampling conversion rate, to thereby compensate and generate an interpolated offset baseband signal. The sampling rate of a data outputted by the interpolator 430 is still an ideal sampling rate, which is defined as K times the symbol rate. For κ=4, it indicates that the output signal of the interpolator 430 has four sampling points within a symbol period. When the sampling is performed at the same position in every symbol, a set of four sampling points is formed, with different sample phases. For example, for κ=4, the sample phases can be phase 0, phase 1, phase 2 and phase 3. Accordingly, the digital baseband signal contains four baseband signals, which correspond to phase 0, phase 1, phase 2 and phase 3 respectively.

The digital matched filter (DMF) 440 is connected to the interpolator 430 in order to perform a filtering on the interpolated offset baseband signal to thereby generate an over-sampled filter baseband signal.

The buffer 450 is connected to the digital matched filter 440 in order to temporarily store the over-sampled filter baseband signal based on the frame timing.

The down-sampler 460 is connected to the buffer 450 in order to perform a down-sampling operation on the over-sampled filter baseband signal based on a phase selection index, to thereby generate a down-sampled filter baseband signal.

When κ=4, the phase selection index indicates one of phases 0 to 3, and one of the four signals contained in the over-sampled filter baseband signal is selected as the down-sampled filter baseband signal.

Since the ADC 410 performs an over-sampling operation based on an over-sampling factor κ, the data rate is restored to the symbol rate after the down-sampler 460 performs a down-sampling operation. Accordingly, the obtained down-sampled filter baseband signal can be regarded as the symbol synchronization achieved on the basis of the selected sample phase.

The channel estimator 470 is connected to the sample phase selector 480 in order to perform a channel estimation base on an indication of a candidate sample phase index outputted by the synchronization 490, and generate a channel frequency response (CFR) corresponding to the candidate sample phase index.

The synchronizer 490 sequentially outputs the candidate output index i for providing the channel estimator 470 to perform a channel estimation. The synchronizer 490 sequentially outputs the candidate output indexes i corresponding to the phases 0 to 3 respectively when κ=4, and the channel estimator 470 calculates the channel frequency responses (CFRs) of the phases 0 to 3 respectively based on the candidate output indexes i. In practice, the input signal required for the channel estimator 470 is determined according to the algorithm used in practice.

The sample phase selector 480 is connected to the down-sampler 460, the channel estimator 470 and the synchronizer 490, in order to calculate a channel capacity corresponding to the candidate sample phase index i based on a channel frequency response (CFR) and a candidate sample phase index i, to thereby select a candidate sample phase with the maximum capacity as the finally selected sample phase corresponding to the phase selection index.

For example, for κ=4, the channel estimator 470 sequentially outputs the CFRs corresponding to the phases 0 to 3, respectively. The sample phase selector 480 calculates the channel capacities corresponding to the phases 0 to 3, respectively, based on the candidate sample phase indexes i and the CFRs. If the channel capacity corresponding to the phase 2 is the maximum, the phase 2 with the maximum channel capacity is selected as the phase selection index j, i.e., j=2. The down-sampler 460 selects a signal corresponding to j=2 from the four signals contained in the over-sampled filter baseband signal as the down-sampled filter baseband signal outputted by the down-sampler 460 based on the phase selection index j.

From Shannon theory, it is known that an additive white Gaussian noise (AWGN) channel has a channel capacity C expressed as:

$$R \leq C = B \cdot {log}_{2} ( 1 + \frac{S}{N} ) ,$$

where R denotes the maximum achievable data transmission rate (bps), B denotes the channel bandwidth, and

$$\frac{S}{N}$$

denotes the signal to noise power ratio.

When the channel under consideration is a frequency selective, the down-sampled filter baseband signal yₙ can be expressed as:

yₙ=xₙ [symbol] hₙ+nₙ,

where yₙ denotes the down-sampled filter baseband signal, xₙ denotes a transmission signal, nₙ denotes noises, [symbol] denotes a circular convolution, and hₙ denotes an entire channel impulse response (CIR). After a Fast Fourier Transform (FFT), the above equation can be expressed as:

Yₖ=Xₖ·Hₖ+Zₖ,

where k denotes a k-th subcarrier, and Hₖ denotes the plurality of channel gains of the k-th subcarrier, and Zₖ denotes noises on the k-th subcarrier. The channel frequency response (CFR) is a set of the channel gains Hₖ, i.e., CFR≡{Hₖ|∀k} which indicates that the channel estimator performs the FFT on a CIR to thereby provide the CFR. Let all channel gains are normalized to unity, i.e., Σₖ|Hₖ|²=1, an average signal energy on the k-th subcarrier can be defined as:

Sₖ≡E└|XₖHₖ|²┘=E└|Xₖ|²┘·E└|Hₖ|²┘=σ_{X}²·|Hₖ|²,

where E[.] denotes a computation of an expected value of probability, and σ_{X}² denotes an average signal power in every subcarrier. The average noise energy (or power) Nₖ on the k-th subcarrier can be defined as:

Nₖ≡E└|Zₖ|²┘=σ_{N}²,

Accordingly, when the channel is frequency selective, the signal-to-noise power ratio on the k-th subcarrier can be expressed as:

$${γ}_{k} ≡ \frac{{σ}_{X}^{2} \cdot {\vert {H}_{k} \vert}^{2}}{{σ}_{N}^{2}} ,$$

and the channel capacity of the k-th subcarrier can be expressed as:

$${C}_{k} ≡ \frac{W}{M} \cdot {log}_{2} ( 1 + \frac{{σ}_{X}^{2} \cdot {\vert {H}_{k} \vert}^{2}}{{σ}_{N}^{2}} ) ,$$

where W denotes the channel bandwidth, and M denotes the number of spectrum sections (subcarriers). In addition, the average signal-to-noise power ratio can be expressed as:

$$γ ≡ \frac{{\sum }_{k}^{M} {S}_{k}}{{\sum }_{k}^{M} {N}_{k}} = \frac{{σ}_{X}^{2}}{{σ}_{N}^{2}} \cdot \frac{1}{M} \cdot {\sum }_{k}^{M} {\vert {H}_{k} \vert}^{2} .$$

When the channel is a frequency selective channel, the total channel capacity C is the sum of channel capacities of all subcarriers, i.e.,

$$C = {\sum }_{k}^{M} {C}_{k} = \frac{W}{M} \cdot {\sum }_{k}^{M} {log}_{2} ( 1 + \frac{{σ}_{X}^{2} \cdot {\vert {H}_{k} \vert}^{2}}{{σ}_{N}^{2}} ) .$$

The proportional constant

$$\frac{W}{M}$$

can be omitted while comparing channel capacities associated with a set of CFR and the equation can be rewritten as follows:

$$\begin{matrix}C ∝ {\sum }_{k}^{M} {log}_{2} ( 1 + \frac{{σ}_{X}^{2} \cdot {\vert {H}_{k} \vert}^{2}}{{σ}_{N}^{2}} ) \\ = {\sum }_{k}^{M} ( {log}_{2} e ) \cdot ln ( 1 + \frac{{σ}_{X}^{2} \cdot {\vert {H}_{k} \vert}^{2}}{{σ}_{N}^{2}} ) \\ = ( {log}_{2} e ) \cdot {\sum }_{k}^{M} ln ( 1 + \frac{{σ}_{X}^{2} \cdot {\vert {H}_{k} \vert}^{2}}{{σ}_{N}^{2}} ) ,\end{matrix} \qquad \begin{matrix}( 1 ) \\ ( 2 )\end{matrix}$$

and

$$ln ( 1 + x ) = {\sum }_{n = 1}^{∞} {( - 1 )}^{n + 1} \cdot \frac{{x}^{n}}{n} as - 1 < x \leq 1 ;$$

thus, equation (2) can be rewritten as:

$$C = ( {log}_{2} e ) \cdot {\sum }_{k}^{M} {\sum }_{n = 1}^{∞} \frac{{( - 1 )}^{n + 1}}{n} \cdot {( \frac{{σ}_{X}^{2} \cdot {\vert {H}_{k} \vert}^{2}}{{σ}_{N}^{2}} )}^{n} . \qquad ( 3 )$$

In addition, at high signal-to-noise ratio (SNR), i.e.

$$\frac{{σ}_{X}^{2} \cdot {\vert {H}_{k} \vert}^{2}}{{σ}_{N}^{2}} >> 1 ,$$

equation (1) can be rewritten as:

$$C \approx {\sum }_{k}^{M} {log}_{2} ( \frac{{σ}_{X}^{2} \cdot {\vert {H}_{k} \vert}^{2}}{{σ}_{N}^{2}} ) ∝ {\sum }_{k}^{M} {log}_{2} \vert {H}_{k} \vert . \qquad ( 1 )$$

Accordingly, at high SNR, the channel capacity C is positively proportional to the item, Σₖ^{M} log₂ (|Hₖ|). At low SNR, the high-order items in equation (3) can be omitted, so equation (3) can be rewritten as:

$$C \approx ( {log}_{2} e ) \cdot {\sum }_{k}^{M} ( \frac{{σ}_{X}^{2} \cdot {\vert {H}_{k} \vert}^{2}}{{σ}_{N}^{2}} ) ∝ {\sum }_{k}^{M} {\vert {H}_{k} \vert}^{2} . \qquad ( 3 )$$

Thus, at low SNR, the channel capacity C is positively proportional to the item Σₖ^{M}|Hₖ|².

The sample phase selector 480 can calculate the channel capacity C⁽ⁱ⁾ of a candidate sample phase corresponding to the candidate sample phase index i based on a channel frequency response (CFR) and a candidate sample phase index i, to thereby select the sample phase corresponding to the candidate sample phase with the maximum capacity among the candidate sample phases as the phase selection index. Namely, the sample phase can be expressed as:

$$\hat{ζ} = arg {Max}_{i} {C}^{( i )} = arg {Max}_{i} {\sum }_{k}^{M} {ψ}_{k}^{( i )} ,$$

where \hat{ζ} denotes the sample phase finally selected by the sample phase selector 480, C⁽ⁱ⁾ denotes the channel capacity of the candidate sample phase, i denotes the candidate sample phase index corresponding to the candidate sample phase, and ψₖ⁽ⁱ⁾ denotes the equivalent simplified comparison expression for the channel capacity corresponding to the candidate sample phase index i. The sample phase selector 480 outputs the index j corresponding to the sample phase \hat{ζ} as the phase selection index. Let {Hₖ⁽ⁱ⁾} be the corresponding CFR of the i-th sample phase. At high SNR, ψₖ⁽ⁱ⁾ is taken as log₂(|Hₖ⁽ⁱ⁾|), and at low SNR, ψₖ is taken as|Hₖ⁽ⁱ⁾|².

In other embodiments, the channel estimator 470 only generates the corresponding CFRs of part of the candidate sample phases indexes i, and the corresponding CFRs of the others are generated by an interpolation or extrapolation to thereby reduce the processing delay caused by the CFR computation.

The equalizer 495 is connected to the down-sampler 460 and the channel estimator 470 in order to perform an equalization operation on the down-sampled baseband signal based on the result of the channel estimation, to thereby cancel the inter-symbol interference. In practice, the result of the channel estimation outputted to the equalizer 495 by the channel estimator 470 is determined according to the algorithm used in practice.

The inner receiver of the receiving device is formed by the digital mixer 420, the interpolator 430, the digital matched filter 440, the buffer 450, the down-sampler 460, the channel estimator 470, the sample phase selector 480, the synchronizer 490 and the equalizer 495, and the output of the equalizer 495 is connected to an outer receiver (not shown) for proceeding further processes such as de-mapping, de-interleaving and channel decoding operations, and the like.

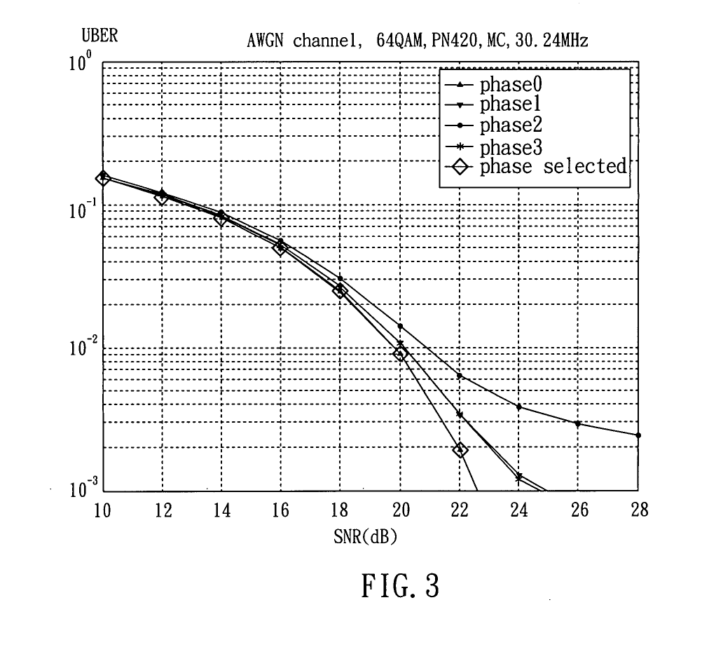

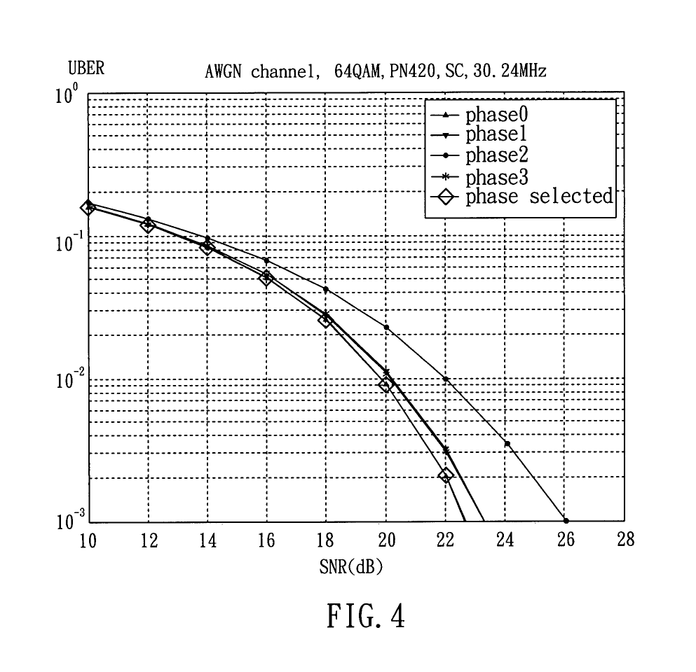

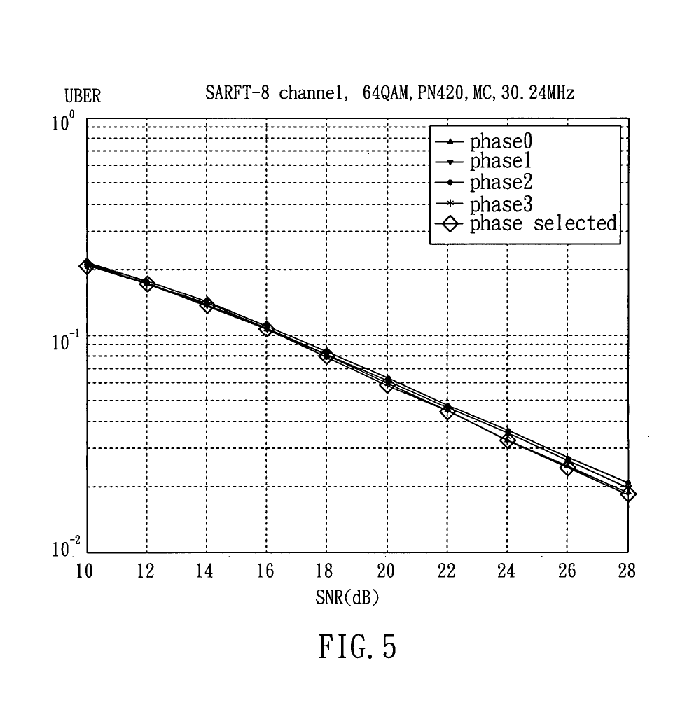

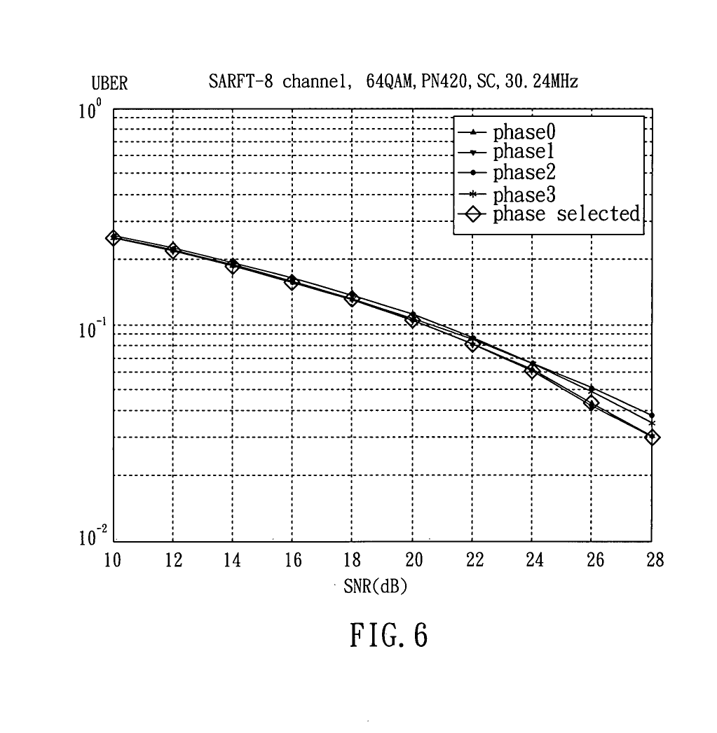

FIGS. 3 to 6 are schematic diagrams of simulations according to the invention. The system parameters are set up based on a DTMB system. In addition, perfect channel estimation and synchronization are assumed. If the system bandwidth is 7.56 MHz and the over-sampling factor κ=4, the sampling rate equals to 30.24 MHz. In simulation, only the CFRs of phases 0 and 2 are calculated, and the CFRs of phases 1 and 3 are obtained by an ideal interpolation or extrapolation. The simplified expression for (comparison at high SNR, i.e., ψₖ⁽ⁱ⁾)=log₂(|Hₖ⁽ⁱ⁾|), is used to compare the channel capacities. The AWGN channel is considered in FIGS. 3 and 4, and the frequency selective channel is considered in FIGS. 5 and 6. Here, a SARFT-8 channel is considered and the feature is shown in Table 1 as follows, where Table 1 shows the parameters of the SARFT-8 channel. Further, FIGS. 3 and 5 are at a multi-carrier mode (MC), and FIGS. 4 and 6 are at single carrier mode (SC). As shown in FIGS. 3 to 6, the vertical axis indicates the uncoded bit error rate (UBER), and the horizontal axis indicates the SNR.

From the illustration of FIGS. 3 to 6, it is known that the channel capacity is varied with different sample timing offsets used to sample a signal, even the same symbol rate is used. Thus, the transmission property is different. Accordingly, the sample timing offsets obtained by the method and associated operations disclosed in Gardner in the prior art are not reliable. However, from FIGS. 3 to 6, it is known that the invention always selects the candidate sample phase with the minimum UBER. Namely, the invention provides a solution that can always selects the best sample phase in terms of UBER performance measure.

TABLE 1

| | The number of paths | | | | | |
|---|---|---|---|---|---|---|
| | 1 | 2 | 3 | 4 | 5 | 6 |
| Path delay | −1.8 | 0.0 | 0.15 | 1.8 | 5.7 | 30 |
| Path attenuation (dB) | −18 | 0 | −20 | −20 | −10 | 0 |
| Path phase | 0 | 0 | 0 | 0 | 0 | 0 |

In the invention, the data rate before the down-sampler 460 is the ideal sampling rate (κ times the symbol rate by definition), and the data rate after the down-sampler 460 is the symbol rate. However, if a sample timing offset on sampling cannot be accurately estimated, the invention provides the candidate sample phases as an option to thereby select the sample phase with the maximum channel capacity. As a result, the best system performance can be achieved.

As cited, the invention provides a method for deciding an optimum sample timing offset, with which the sampling rate to a signal of the output terminal of the interpolation 430 is kept at ideal sampling rate (κ times the symbol rate by definition), and in this case, κ different signals with the symbol rate are obtained after an κ-time down-sampling operation is performed with different sample phases on the signal. Thus, selecting the sample phases is equivalent to selecting different sample timing offsets. Namely, one of the sample phases is selected properly to thereby obtain the optimum sample time offset. Thus, the symbol synchronization is achieved, and the system performance is improved. The invention uses the magnitudes of each channel capacity as a basis for selecting the sample phases.

As cited, the data after the interpolator in the prior art is operated at symbol rate, and thus, there is no way to make any compensation when the sample timing offset estimated by the synchronizer cannot optimize the system performance. However, the invention overcomes that shortcoming by providing the channel-capacity-based sample phase selection in the symbol synchronization. Namely, the invention provides a new method and system for selecting sample phases to thereby make up for the insufficiency of the prior symbol synchronization. The prior art does not provide the candidate sample phases to be selected based on the magnitudes of each channel capacity for optimizing the system performance, as shown in the invention. Therefore, the invention can achieve better system performance in comparison with the prior art, by means of the channel-capacity-based sample phase selection.

Although the present invention has been explained in relation to its preferred embodiment, it is to be understood that many other possible modifications and variations can be made without departing from the spirit and scope of the invention as hereinafter claimed.

What is claimed is:

1. A system for selecting a sample phase based on channel capacity, applied to a receiver of a communication system in which a carrier is used to transmit signals, the system comprising:
a synchronizer, estimating a carrier frequency offset (CFO), a sample timing offset, a sampling conversion rate and a frame timing in the communication system, and counting candidate sample phases to be selected;
a digital mixer, connected to the synchronizer for receiving a digital baseband signal and performing a frequency compensation on the digital baseband signal based on the carrier frequency offset to generate an offset baseband signal;
an interpolator, connected to the digital mixer and the synchronizer, for performing an interpolation operation on the offset baseband signal based on the sample timing offset and the sampling conversion rate to generate an interpolated offset baseband signal;
a digital matched filter, connected to the interpolator for performing a filtering on the interpolated offset baseband signal to generate an over-sampled filter baseband signal;
a buffer, connected to the digital matched filter for temporarily storing the over-sampled filter baseband signal based on the frame timing;
a down-sampler, connected to the buffer for performing a down-sampling operation on the over-sampled filter baseband signal based on a phase selection index to generate a down-sampled filter baseband signal; and
a sample phase selector, connected to the down-sampler for calculating a channel capacity corresponding to the candidate sample phase index based on a channel frequency response and a candidate sample phase index to select a candidate sample phase with the maximum capacity as the phase selection index;
wherein the over-sampled filter baseband signal has multiple baseband signals, and the phase selection index is provided for generating the down-sampled filter baseband signal based on one of the baseband signals.

2. The system as claimed in claim 1, further comprising an analog to digital converter connected to the digital mixer for converting an analog baseband signal into the digital baseband signal based on an over-sampling factor.

3. The system as claimed in claim 2, further comprising a channel estimator connected to the sample phase selector for performing the channel estimation based on the candidate sample phase index to generate the channel frequency response.

4. The system as claimed in claim 1, wherein the channel capacity for a frequency selective channel is expressed as:
$$C = \frac{W}{M} \cdot {\sum }_{k}^{M} {log}_{2} ( 1 + \frac{{σ}_{X}^{2} \cdot {\vert {H}_{k} \vert}^{2}}{{σ}_{N}^{2}} ) ,$$
where C denotes the channel capacity, W denotes a channel bandwidth, M denotes the number of spectrum sections, σ_{X}² denotes an average signal power in each spectrum section, σ_{N}² denotes an average noise power in each spectrum section, Hₖ denotes a plurality of channel gains of a k-th spectrum section, and the channel frequency response is a set of Hₖ.

5. The system as claimed in claim 4, wherein the channel capacity is positively proportional to Σhd k^{M} log₂(|Hₖ|) when the frequency selective channel is at high signal-to-noise ratio (SNR).

6. The system as claimed in claim 4, wherein the channel capacity is positively proportional to Σₖ^{M}|Hₖ|² when the frequency selective channel is at low SNR.

7. The system as claimed in claim 4, wherein the sample phase is expressed as:
$$\hat{ζ} = arg {Max}_{i} {C}^{( i )} = arg {Max}_{i} {\sum }_{k}^{M} {ψ}_{k}^{( i )} ,$$
where C⁽ⁱ⁾ denotes the channel capacity of the candidate sample phase, i denotes the candidate sample phase index, and ψₖ⁽ⁱ⁾ denotes an equivalent simplified comparison expression for the channel capacity corresponding to the candidate sample phase index i.

8. The system as claimed in claim 7, wherein, the comparison expression ψₖ⁽ⁱ⁾ is positively proportional to log₂(|Hₖ⁽ⁱ⁾|) when the channel has a high SNR, where {Hₖ⁽ⁱ⁾} denotes the channel frequency response of i-th sample phase.

9. The system as claimed in claim 7, wherein the comparison expression ψₖ⁽ⁱ⁾ is positively proportional to |Hₖ⁽ⁱ⁾|² when the channel has a low SNR.

10. The system as claimed in claim 3, wherein the channel estimator generates channel frequency responses corresponding to part of candidate sample phase indexes, and the channel frequency responses corresponding to the others are generated by an interpolation or extrapolation.

11. The system as claimed in claim 3, further comprising an equalizer connected to the down-sampler and the channel estimation for performing an equalization operation on the down-sampled baseband signal based on the channel frequency response to cancel an inter-symbol interference.
